(19) United States
(12) Patent Application Publication
(10) Pub. No.: US 2006/0027058 A1
(43) Pub. Date: Feb. 9, 2006

(54) Electronic torque wrench

(76) Inventor: Chih-Ching Hsien, Taichung (TW)

Correspondence Address: Mr. Phillip Liu, 6980, Whiteoak Dr., Richmond, BC, V7E 4Z9, CA

(21) Appl. No.: 10/910,286

(22) Filed: Aug. 4, 2004

(51) Int. Cl. B25B 23/14

(52) U.S. Cl. 81/467

(57) ABSTRACT

An electronic torque wrench includes a work section connected to a first end of the handle and having a clamping space so as to accommodate an object to be tightened or loosened. A resistive strain gauge is received in the handle and located at a position within a range from ⅛ to 3/16 of a length from a center of the clamping space to the second end of the handle.

### FIELD OF THE INVENTION

The present invention relates to an electronic torque wrench that includes a resistive strain gauge embedded in the handle and located at a position equal to ⅛ to 3/16 of the length from a clamping center of the work section of the wrench to a remote end of the handle.

### BACKGROUND OF THE INVENTION

A conventional electronic torque wrench includes a handle and a work section such as a box end or two open-ended jaws connected to an end of the handle, and a resistive strain gauge is embedded in the handle so that when outputting a torque, the handle is slightly deformed and the resistance changes is detected by the strain gauge so as to transfer the change into digits. By using the electronic torque wrench, the user knows the value of the torque is applied to the object which is protected from being over-rotated and damaged. It is experienced that the position that the strain gauge is located in the handle is crucial for the accuracy of the detection. If the strain gauge is located too close to the work section, the structural strength of the work section is weakened because a recess has to be drilled in the work section to receive the strain gauge. On the contrary, if the strain gauge is located away from the work section, the deformation is not correctly respondent to the value torque and the accuracy is questionable.

The present invention intends to provide an electronic torque wrench wherein the strain gauge is embedded in a position that is ⅛ to 3/16 of a length from a center of clamping area to a remote end of the handle.

### SUMMARY OF THE INVENTION

The present invention relates to an electronic torque wrench that comprises a work section connected to a first end of a handle and having a clamping space for accommodating an object to be tightened or loosened. A resistive strain gauge is received in the handle and located at a position within a range from ⅛ to 3/16 of a length from a center of the clamping space to a second end of the handle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the electronic torque wrench of the present invention;

FIG. 2 is a top view of the electronic torque wrench of the present invention;

FIG. 3 is a side view of the electronic torque wrench of the present invention, and

FIG. 4 shows the wrench is rotated by a user.

### DETAILED DESCRIPTION OF THE PREFERRED EMBODIMENT

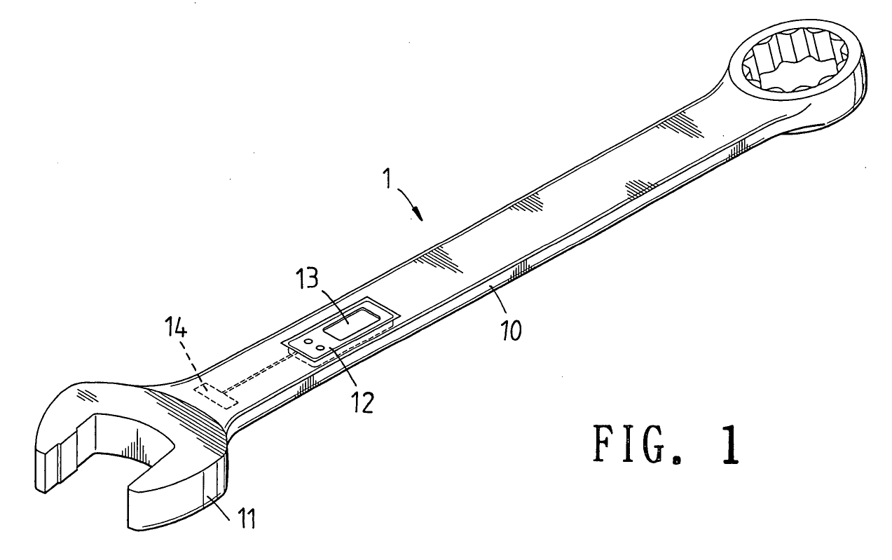

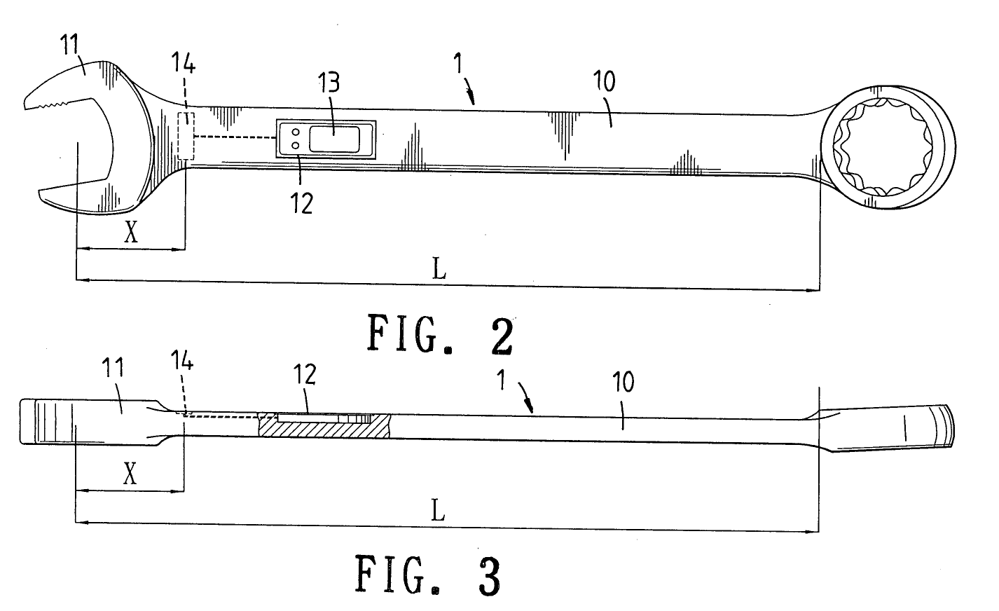

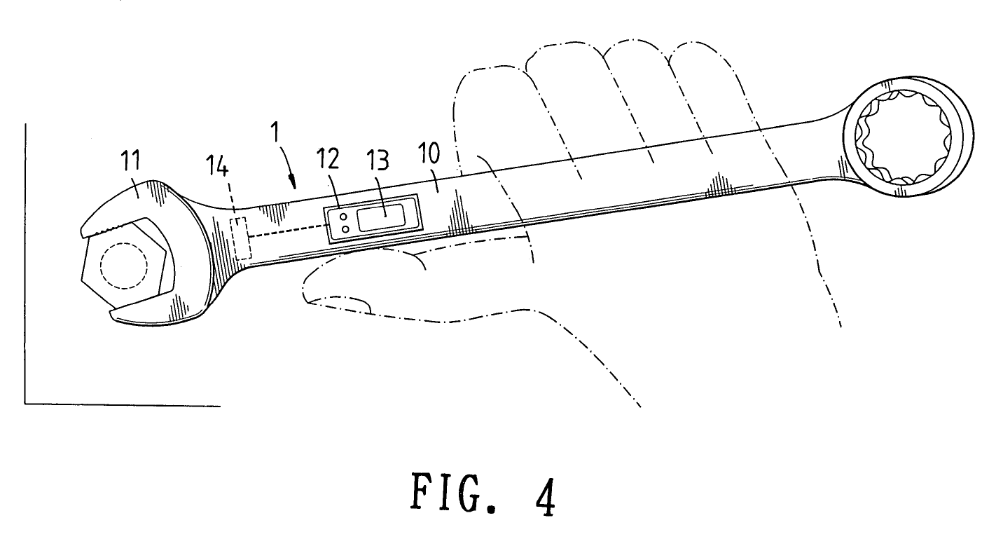

Referring to FIGS. 1 to 4, the electronic torque wrench 1 of the present invention comprises a work section 11 which includes two jaws in this embodiment, and a clamping space for accommodating an object to be tightened or loosened is defined between the two jaws. A handle 10 which has a first end fixed to the work section 11 and a second end which is connected to a box end.

A resistive strain gauge 14 is received in the handle 10 and located at a position within a range “X” from ⅛ to 3/16 of a length “L” from a center of the clamping space to the second end of the handle 10. A display unit 12 with a screen 13 are electrically connected to the resistive strain gauge 14. When the user holds the handle 10 and rotates the handle 10 to apply a torque to a nut clamped between the two jaws of the work section 11, the strain gauge 14 detects a deformation of the handle 10 and the change of resistance is transferred to digits shown on the screen 13 such that the user knows the exact torque that is applied to the nut. The specific position that the strain gauge 14 is located reflects the real deformation of the handle 10 so as to provide accurate torque value.

While we have shown and described the embodiment in accordance with the present invention, it should be clear to those skilled in the art that further embodiments may be made without departing from the scope of the present invention.

What is claimed is:

1. An electronic torque wrench comprising:
a work section having a clamping space adapted to accommodate an object to be tightened or loosened, and a handle which has a first end fixed to the work section and a second end, and
a resistive strain gauge received in the handle and located at a position within a range from ⅛ to 3/16 of a length from a center of the clamping space to the second end of the handle.

2. The wrench as claimed in claim 1 further comprising a display unit with a screen electrically connected to the resistive strain gauge.
